(19) United States
(12) Patent Application Publication
(10) Pub. No.: US 2025/0182266 A1
(43) Pub. Date: Jun. 5, 2025

(54) WAFER INSPECTION USING A DYNAMIC SCAN PLAN

(71) Applicant: Applied Materials Israel Ltd, Rehovot (IL)

(72) Inventors: Prashanth Venkatarama Reddy, Bangalore (IN); Zvi Nir, Karme Yosef (IL); Amit Agrawal, Bhatapara Chhattisgarh (IN); Marshall Samson Rajasing, Podanur Coimbatore (IN); Piyush Agrawal, Banagalore Karnataka (IN); Kavya Kalasa Manjunatha, Banaswadi Bengaluru (IN); Prabir Kumar Panda, Marathahalli Bengaluru (IN); Arihant Bapna, Whitefield Bangalore (IN)

(73) Assignee: Applied Materials Israel Ltd., Rehovot (IL)

(21) Appl. No.: 18/529,495

(22) Filed: Dec. 5, 2023

(51) Int. Cl. G06T 7/00; G01N 21/95; G01N 21/956

(52) U.S. Cl. CPC G06T 7/001; G01N 21/9501; G01N 21/956; G06T 2207/30148

(57) ABSTRACT

A wafer inspection system, that includes (a) a scanner configured to scan, while following a dynamic scan plan, a set of tiles that are associated with a region of interest of a die of a wafer to provide a set of tiles scanning results; (b) a comparison circuit configured to compare the set of tiles scanning results to reference items to provide a set of comparison results, at least some of the reference items were generated based on one or more other sets of tiles scanning results generated by scanning one or more other sets of tiles associated with one or more other regions of interest; and (c) a decision circuit configured to determine, based on the set of comparison result, a state of the region of interest; and generate new reference items based on at least some of the set of tiles scanning results.

### BACKGROUND OF THE INVENTION

Fabricating semiconductor devices such as logic and memory devices typically includes processing a substrate such as a semiconductor wafer using a large number of semiconductor fabrication processes to form various features and multiple levels of the semiconductor devices. For example, lithography is a semiconductor fabrication process that involves transferring a pattern from a reticle to a resist arranged on a semiconductor wafer. Additional examples of semiconductor fabrication processes include, but are not limited to, chemical-mechanical polishing, etch, deposition, and ion implantation. Multiple semiconductor devices may be fabricated in an arrangement on a single semiconductor wafer and then separated into individual semiconductor devices.

Inspection processes are used at various steps during a semiconductor manufacturing process to detect defects on wafers to promote higher yield in the manufacturing process and thus higher profits. Inspection has always been an important part of fabricating semiconductor devices such as integrated circuits. However, as the dimensions of semiconductor devices decrease, inspection becomes even more important to the successful manufacture of acceptable semiconductor devices because smaller defects can cause the devices to fail. For instance, as the dimensions of semiconductor devices decrease, detection of defects of decreasing size has become necessary since even relatively small defects may cause unwanted aberrations in the semiconductor devices.

As design rules shrink, semiconductor manufacturing processes may also be operating closer to the limitations on the performance capability of the processes. In addition, at smaller design rules, process induced failures may, in some cases, tend to be systematic. That is, process induced failures tend to fail at predetermined design patterns often repeated many times within the design. Detection and elimination of spatially systematic, electrically relevant defects is important because eliminating such defects can have a significant overall impact on yield.

However, detection of defects using inspection techniques such as die-to-die inspection and die to standard reference die inspection are disadvantageous for several reasons. By comparing two test die to each other/reference. In addition, die to standard reference die inspection techniques have been also adopted, which also has challenges in creating the standard reference and longevity and variance concerns in this golden reference.

### BRIEF SUMMARY OF THE INVENTION

There is provided a wafer inspection system that includes (i) a scanner that is configured to scan, while following a dynamic scan plan, a set of tiles that are associated with a region of interest of a die of a wafer, to provide a set of tiles scanning results; (ii) a comparison circuit that is configured to compare the set of tiles scanning results to reference items to provide a set of comparison results, at least some of the reference items were generated based on one or more other sets of tiles scanning results generated by scanning one or more other sets of tiles that were associated with one or more other regions of interest; and (iii) a decision circuit that is configured to determine, based on the set of comparison results, a state of the region of interest; and generate new reference items based on at least some of the set of tiles scanning results.

There is provided a method for wafer inspection, the method comprises, the method includes (i) scanning, by a wafer inspection system and while following a dynamic scan plan, a set of tiles that are associated with a region of interest of a die of a wafer to provide a set of tiles scanning results; (ii) comparing the set of tiles scanning results to reference items to provide a set of comparison results; wherein at least some of the reference items were generated based on one or more other sets of tiles scanning results generated by scanning one or more other sets of tiles that were associated with one or more other regions of interest; (iii) determining, based on the set of comparison results, a state of the region of interest; and (iv) generating new reference items based on at least some of the set of tiles scanning results.

There is provided a non-transitory computer readable medium for wafer inspection, the non-transitory computer readable medium stores instructions that once executed by an inspection system, cause the inspection system to: (i) scan, while following a dynamic scan plan, a set of tiles that are associated with a region of interest of a die of a wafer to provide a set of tiles scanning results; (ii) compare the set of tiles scanning results to reference items to provide a set of comparison results; wherein at least some of the reference items were generated based on one or more other sets of tiles scanning results generated by scanning one or more other sets of tiles that were associated with one or more other regions of interest; (iii) determine, based on the set of comparison results, a state of the region of interest; and (iv) generate new reference items based on at least some of the set of tiles scanning results.

### BRIEF DESCRIPTION OF THE DRAWINGS

The subject matter regarded as the embodiment is particularly pointed out and distinctly claimed in the concluding portion of the specification. The embodiment, however, both as to organization and method of operation, together with specimen s, features, and advantages thereof, may best be understood by reference to the following detailed description when read with the accompanying drawings in which:

FIG. 1 illustrates an example of a method;

FIG. 2 illustrates an example of a method;

FIG. 3 is an example of an inspection system; and

FIG. 4 illustrates an example of a wafer.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

Inspection may perform a die to (golden) reference comparison in order to detect defects or suspected defects.

The reference is usually created based on images, at least some of which are acquired during an imaging state of an inspection system that differs from a current state of the inspection system during inspection. Hence, even though there would not be any defects in a die of the wafer, an inspection algorithm may generate inaccurate (for example false) alarms while inspecting a defect free die. The variation in images (acquired during inspection versus acquired during a generation of the reference) may be attributed due to the variation of at least one of (i) time from calibration to image generation, (b) distance from the center of wafer, (c) absolute time of imaging, (d) inspection system matching, or (e) inspection system aging.

To dynamically create a good reference, there may be a need to retain the defect inspection process with all the images grabbed so far. Due to memory limitations, the memory may store only a limited number of images, thus resulting in not using most appropriate images for reference creation.

Yet another ineffective method for generating references includes re-scan the die with the required constraints—but this will dramatically decrease the throughput of the inspection system.

Furthermore—storing a large number of images for reference generation will require using a vast and remote storage unit, which is exhibit much higher latency.

According to an embodiment there is provided a method, an inspection system and non-transitory computer readable medium, for generating reference in a highly effective manner. For simplicity of explanation, the following will mostly refer to a method.

The method may obtain information about regions of interest to be inspected. The method may determine one or more regions of interest or may receive input regarding the one or more regions of interest. For example, a user may define one or more regions of interest-for example at locations that were currently amended and/or at locations that can impact the performance of the wafer, and/or locations that are error prone, and the like.

The regions of interest should be acquired—but in order to comply with various constraints—an region of interest may be virtually segmented to tiles. One tile can be independently acquired and/or processed from another tile. According to an embodiment, the constraints include at least one of image quality, pixel size, memory required to store the entire region of interest, memory constraints, scanner constraints, and the like.

According to an embodiment, tiles related to a region of interest fully cover the region of interest—with or without at least partial overlap between adjacent tiles.

According to an embodiment, the regions of interest are of any shape and/or size.

According to an embodiment, tiles related to the regions of interest are of any shape and/or size—but should be smaller than the regions of interest associated with the tiles.

According to an embodiment, different tiles differ from each other by shape and/or size.

According to an embodiment, a tile size is determined based on at least one tile related parameters of:
a. Image quality.
b. Field of view.
c. A relationship between image quality and field of view.
d. Having a defined number of tiles in x-axis direction and/or y-axis direction (especially when the tiles are of the same size).
e. Overlap/underlap requirements of the layer of the die being inspected.
f. One or more other constraints related to the inspection system—such as imaging condition required to maintain at least a minimal desired quality, a field of view required without impacting basic quality.

According to an embodiment, the determination of the tile size is a part of a dynamic scan plan.

According to an embodiment, the dynamic scan plan fulfills at least one of the following:
a. The dynamic scan plan includes a list of all tiles, groups and batches. Each tile contains location on which we need to go and grab images.
   i. According to an embodiment, the tile size defines a temporal field of view of the inspection.
   ii. According to an embodiment, a group of tiles include the tiles in a same die which should be acquired before moving to another die.
   iii. According to an embodiment, a batch includes tiles that are acquired between one auto focus calibration to another. The batch may be defined based on auto focus radius.
b. According to an embodiment, the dynamic scan plan is defined to provide an inspection performance tradeoff (optimal tradeoff, sub-optimal tradeoff or any desired tradeoff) based on aspects such mechanical stage movements (which translated to minimum wafer movements, for example to a minimal movements), inspection system calibrations required during the applying of the dynamic scan plan, and resource constraints, such as available a total memory to hold tile images, intermediate images and additional data.

According to an embodiment, the method is applied for scanning non-repetitive patters.

According to an embodiment, the method is applied for scanning repetitive patterns.

According to an embodiment, the defining of the dynamic scan plan includes (i) defining tiles of specific die and duplicating the tiles over multiple other dies, and (ii) maintaining reference tiles number with the tiles. According to an embodiment, the reference tine number are used to create detection scheduler and finally die comparison.

According to an embodiment the scanning is performed on a tile-to-tile basis (usually regarding tiles of the same region of interest).

According to an embodiment, different tiles of a wafer are used as reference items to other tiles, and a mapping between reference items to the tiles compared to the reference tiles is maintained. An example of the mapping is a static dependency graph.

According to an embodiment, the determination of the dynamic scan plan includes determining a relevancy of a reference item to a comparison with a tile scanning result of a set of tile scanning results is based on at least one of (i) a distance between a tile associated with the tile scanning result, (ii) a reference tile associated with the reference item, or (iii) a process variation attribute associated with the wafer.

For example—selecting the reference item is based on at least one of (i) closeness in time (during inspection) between the reference item and the tile, (ii) shortest distance of the reference item from the current location, (iii) image quality, or (iv) a state of the inspection system.

According to an embodiment, the determining of the dynamic scan plan is based on memory constraints and/or on processing power constraints.
a. According to an embodiment, the memory constraints and/or on processing power constraints are used to determine a scanning path-an order in which the tiles are acquired.
b. According to an embodiment, the number of tiles to be acquired consecutively before moving to a next die is determined based on available memory.

According to an embodiment, during the execution of the dynamic scan plan, tiles are scanned to provide tiles scanning results that are stored in memory.

According to an embodiment, the tiles scanning results are utilized for at least one of:
a. Being used for evaluating the tiles—for detecting defects of the tiles.
b. Being used (directly or after being further processed) as reference items.

According to an embodiment a reference item is compared to multiple tiles scanning results of multiple other tiles.

A reference item related to a tile of a die, of a group and of a batch is compared to one or more other tiles. Another tile (of the one or more other tiles) may be located at the same die or may be located at another die, may belong to the same batch or to another batch, and the like.

According to an embodiment, the one or more other tiles are used during comparisons to scanning result of at least 2, 3, 4, 5, 6, and even tiles.

According to an embodiment, a larger group increase a number of defect detection decisions waiting for a tile grabs from a last group—resulting in processing tail at the end impacting the throughput.

According to an embodiment, a desired group size is chosen based on available memory and allowed latency.

According to an embodiment, once a tile image had served its purpose (the tile is inspected and not used as a reference item) the tile image is removed from a memory of the inspection system to free up the space for subsequent operations and images.

According to an embodiment, a tile image is eligible for removal from the memory of the inspection system includes at least one of:
a. The required references count is less than an available reference count.
b. Under the previous condition the tile image is no longer required when the tile image has been stored in memory for a longest period out of storage periods of other stored tile images.
c. A quality of tile image is lower than a quality of other stores tiles images.

According to an embodiment, the inspection system is designed for use based on constraints such as constraints related to memory resources and/or processing resources.

According to an embodiment, resources (memory resources and/or processing resources) consumption differs from one layer of the wafer to another. The dynamic scan plan of one layer may differ from the dynamic scan plan of another layer. For example—layers that require more resources may be associated with smaller tiles.

According to an embodiment, the method includes performing error recovery.

According to an embodiment, the error recovery includes at least one of:
a. Recovering from a tile failure. According to an embodiment, when a tile grab failed, the method performs a retry on the failed tile after a performing system recovery (for example, performed at end of scanning group or a batch) or stops the scan in case of automatically unrecoverable error.
b. Recovering from a registration failure between tiles. According to an embodiment, the method masks a tiles associated the registration failure and dynamically changes the dependency of other tiles on the masked tile (dependency—to be compared when using a reference item related to the masked tile or to be used for registration based on the masked time).
c. Detection failure. According to an embodiment, the method determines, based on the failure, whether to continue scanning after masking a tile or after having a fail scan or whether to grab a tile again.

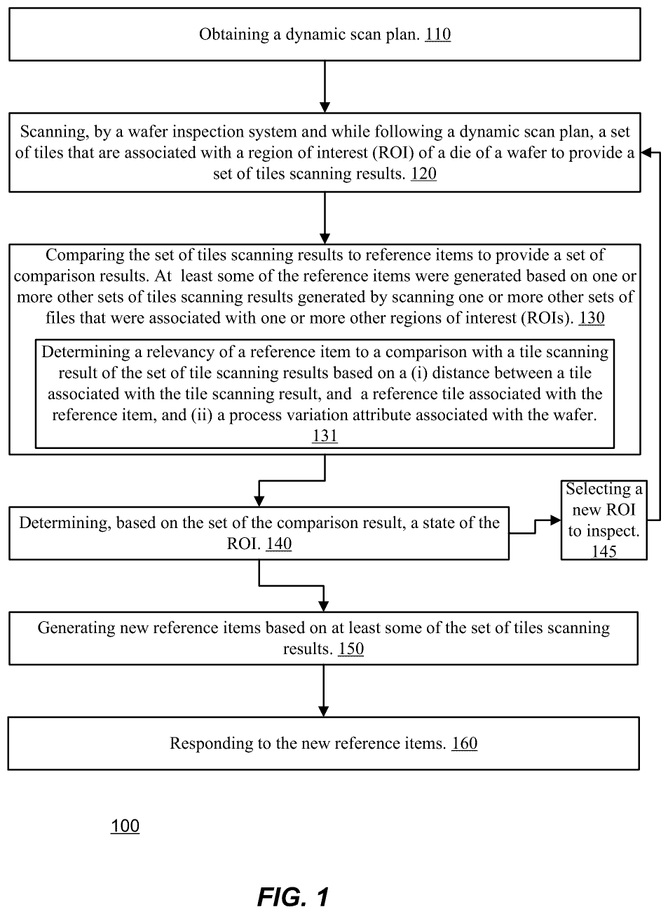

FIG. 1 illustrates an example of method 100 for wafer inspection.

According to an embodiment, method 100 starts by step 110 of obtaining a dynamic scan plan.

According to an embodiment, step 110 includes receiving at least a part of the dynamic scan plan.

According to an embodiment, step 110 includes generating at least a part of the dynamic scan plan.

According to an embodiment, the dynamic scan plan defines tiles, groups and batches. According to an embodiment tiles of a region of interest are scanned and then tiles of one or more other regions of interest of the same dies are scanned until a group of tiles is scanned and tiles of another group of tiles are scanned.

According to an embodiment tiles of a region of interest of a batch of tiles is scanned and then tiles of one or more other regions of interest of the same batch are scanned until the tiles of the batch are scanned and tiles of another batch of tiles are scanned

According to an embodiment, the dynamic scan plan is based on one or more tile parameters, wherein the one or more tile parameters are determined based on at least one of: (i) an image quality threshold related to an acquisition of an image of a tile acquired while following the dynamic scan plan, or (ii) a field of view used while following the dynamic scan plan.

According to an embodiment, the dynamic scan plan is determined based on at least one of (i) a mechanical stage movement parameter indicative of one or more mechanical movements of the wafer during an execution of the dynamic scan plan, (b) a calibration parameter related to a calibration necessitated during the execution of the dynamic scan plan, or (c) a memory resource parameter related to a consumption of one or more memory resources required during the execution of the dynamic scan plan.

According to an embodiment, step 110 includes dynamically updating the dynamic scan plan based on temporal changes in an availability of wafer inspection resources allocated for the wafer inspection. According to an embodiment, the dynamic update is trigger per each period of time and/or whenever a temporal change of interest is detected.

According to an embodiment, the dynamic update includes changing one or more parameters. According to an embodiment, the dynamic update includes changing one or more definitions of the dynamic scan plan.

According to an embodiment, the change impacts a definition of one or more tiles, the definition of one or more groups, a definition of one or more batches, and the like.

According to an embodiment, step 110 is followed by step 120 of scanning, by a wafer inspection system and while following a dynamic scan plan, a set of tiles that are associated with a region of interest of a die of a wafer to provide a set of tiles scanning results.

According to an embodiment, step 120 is followed by step 130 of comparing the set of tiles scanning results to reference items to provide a set of comparison results. At least some of the reference items were generated based on one or more other sets of tiles scanning results generated by scanning one or more other sets of tiles that were associated with one or more other regions of interest.

According to an embodiment, step 130 includes step 131 of determining a relevancy of a reference item to a comparison with a tile scanning result of the set of tile scanning results based on a (i) distance between a tile associated with the tile scanning result, and a reference tile associated with the reference item, and (ii) a process variation attribute associated with the wafer.

According to an embodiment, step 130 is followed by step 140 of determining, based on the set of the comparison result, a state of the region of interest.

According to an embodiment, step 140 is followed by step 145 of selecting a new region of interest to inspect (according to the dynamic scan plan) and jumping to step 120. This is illustrated by a dashed line between steps 140, 145 and step 120. The jump is executed as long that there is a new region of interest to inspect (according to the dynamic scan plan).

According to an embodiment, step 140 is followed by step 150 of generating new reference items based on at least some of the set of tiles scanning results.

According to an embodiment, step 150 is followed by step 160 of responding to the new reference items.

According to an embodiment, step 160 includes comparing a new reference item to a number (defined in the dynamic scan plan) of tiles scanning results of further one or more regions of interest. The number exceeds two. According to an embodiment, the number is determined based on a memory availability attribute and a comparison latency attribute. For example—it is beneficial to increase the number when there are fewer available memory resources (increases memory utilization)—while there are more tolerable latencies (as different comparisons to the reference item may be executed in a sequential manner).

According to an embodiment, the responding includes determining which reference items to delete from memory.

According to an embodiment, multiple regions of interest of the wafers are inspected by executing multiple iterations of steps 120-150.

According to an embodiment, method 100 also includes step 160 of performing a recovery process following a completion of a partially failed scanning a batch of tiles.

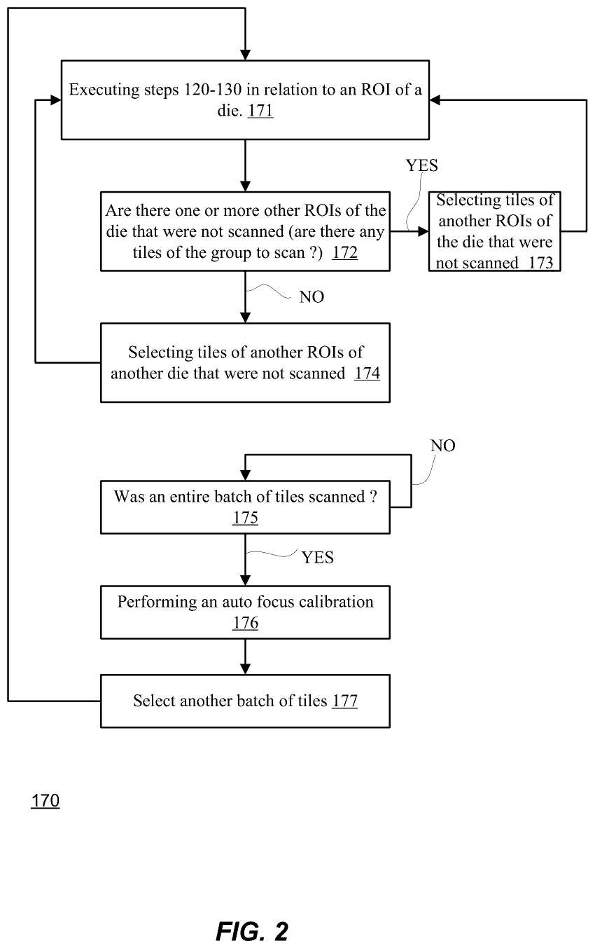

FIG. 2 illustrates an example of a method 170 for scanning tiles.

According to an embodiment, method 170 starts by step 171 of executing steps 120-130 on a region of interest of a die. According to an embodiment, step 171 may include executing steps 120-150.

According to an embodiment, step 171 is followed by step 172 of checking whether there are one or more regions of interest of the die that were not scanned. In other words-are there tiles of a group of tiles that were not scanned.

According to an embodiment, when there are one or more regions of interest of the die that were not scanned—step 172 is followed by step 173 of selecting tiles of a region of interest of the die that were not scanned and jumping to step 171.

According to an embodiment, when all regions of interest of the die were scanned step 172 is followed by step 174 of selecting tiles of another regions of interest of another die that were not scanned and jumping to step 171.

According to an embodiment, method 170 also include step 175 of determining weather an entire batch of tiles was scanned.

According to an embodiment, when an entire batch of tiles was scanned step 175 is followed by step 176 of performing an auto focus calibration.

According to an embodiment, step 176 is followed by step 177 of selecting another batch of tiles and jumping to step 171.

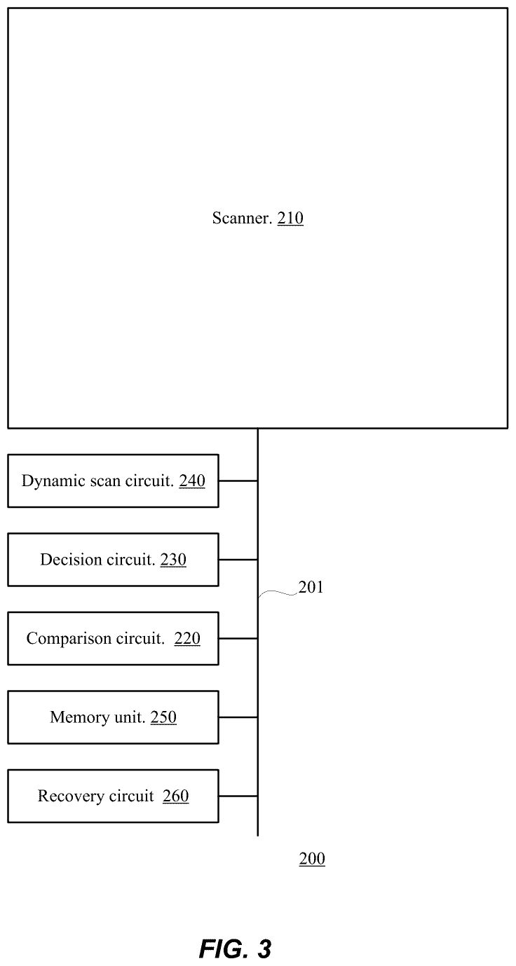

FIG. 3 illustrates an example of a wafer inspection system 200.

According to an embodiment, wafer inspection system 200 includes:
a. Scanner 210 that is configured to scan, while following a dynamic scan plan, a set of tiles that are associated with a region of interest of a die of a wafer to provide a set of tiles scanning results. The scanner includes optics for scanning one tile after the other. According to an embodiment, the optics include a radiation source, a sensing unit, an illumination path, a collection path, and a controller for controlling the scanner.
b. Comparison circuit 220 that is configured to compare the set of tiles scanning results to reference items to provide a set of comparison results; wherein at least some of the reference items were generated based on one or more other sets of tiles scanning results generated by scanning one or more other sets of tiles that were associated with one or more other regions of interest.
c. Decision circuit 230 that is configured to (i) determine, based on the set of the comparison result, a state of the region of interest; and (ii) generate new reference items based on at least some of the set of tiles scanning results.

FIG. 3 also illustrates that the inspection system includes dynamic scan circuit 240 that is configured to dynamically update the dynamic scan plan based on temporal changes in an availability of wafer inspection resources allocated for the wafer inspection.

According to an embodiment, the dynamic scan circuit 240 is configured to determine the dynamic scan plan based on one or more tile parameters, wherein the one or more tile parameters are determined based on at least one of: (i) an image quality threshold related to an acquisition of an image of a tile acquired while following the dynamic scan plan, or (ii) a field of view used while following the dynamic scan plan.

According to an embodiment, the dynamic scan circuit 240 is configured to determine the dynamic scan plan based on at least one of (i) a mechanical stage movement parameter indicative of one or more mechanical movements of the wafer during an execution of the dynamic scan plan, (b) a calibration parameter related to a calibration necessitated during the execution of the dynamic scan plan, or (c) a memory resource parameter related to a consumption of one or more memory resources required during the execution of the dynamic scan plan.

According to an embodiment, the decision circuit 230 is configured to determine a relevancy of a reference item to a comparison with a tile scanning result of the set of tile scanning results based on a (i) distance between a tile associated with the tile scanning result, and a reference tile associated with the reference item, and (ii) a process variation attribute associated with the wafer.

According to an embodiment, the comparison circuit 220 is further adapted to compare a new reference item to a number, defined in the dynamic scan plan, of tiles scanning results of further one or more regions of interest, wherein the number exceeds two, wherein the number is determined based on a memory availability attribute and a comparison latency attribute.

According to an embodiment, the set of tiles belongs to a group of tiles, and the scanner 210 is configured to scan, while following the dynamic scan plan, one or more additional sets of tiles of the group of tiles before scanning one or more tiles of one or more other groups of tiles of one or more other dies of the wafer.

According to an embodiment, the group of tiles belongs to a batch of tiles, and the scanner 210 is configured to scan, while following the dynamic scan plan, one or more additional groups of tiles of the batch of tiles before performing an auto-focus calibration and then proceeding to scan one or more tiles of one or more other batches of tiles of one or more further dies of the wafer.

According to an embodiment, the wafer inspection system includes a recovery circuit 260 that is configured to perform a recovery process following a completion of a partially failed scanning a batch of tiles.

According to an embodiment each one of the comparison circuit 220, the decision circuit 230, dynamic scan circuit 240 includes one or more processing circuits and one or more memory units.

For simplicity of explanation, FIG. 3 illustrates memory unit 250. According to an embodiment, the memory unit is non-transitory although the memory unit may be transitory or include a combination of transitory and non-transitory units. For example, memory unit 250 may be a random access memory (RAM) and/or may be a read only memory (ROM).

According to an embodiment, the non-volatile memory unit is a storage device, which can provide non-volatile storage of code readable by a computer, software, computer readable instructions, one or more program modules, data structures and other data for at least one of the decision circuit 230, the comparison circuit 220, the dynamic scan circuit 240 and the recovery circuit 260. The storage device may be removable or non-removable, may be at least one of a compact disk read only memory (CD-ROM), a hard disk, an optical disk, a magnetic disk, a memristor memory, a magnetic cassette, another other magnetic storage-device, a flash memory, a digital versatile disk (DVD), another optical storage, a random access memory, and the like.

Any content may be stored in any part or any type of the memory unit.

According to an embodiment, the memory unit stores at least one database—such as any database known in the art including an open source data base, a propriety data base, an SQL based data base, a database of any known vendor, including MICROSOFT™, ORACLE™ database, and the like.

Various units and/or components are in communication with each other using any communication elements and/or protocols. An example of a communication element is bus 201. Other communication elements may be provided.

FIG. 3 illustrates a bus 201 used for communication between the following entities—the scanner 210, the comparison circuit 220, the decision circuit 230, the dynamic scan circuit 240, the memory unit 250 and the recovery circuit 260.

It should be noted that only some of the entities may be in communication with each other.

The entities or any sub-combination of the entities can be in communication with each other in any manner—using wireless communication, using wireless communication, using a bus, using multiple buses, using a network (being a wired network or a wireless network, or a hybrid network that includes wireless and wired parts), the network may be a local network, a global network (for example the Internet) or may exhibit any geographical coverage. Examples of bus types include Peripheral Component Interconnects (PCI), PCI-express bus, Universal Serial Bus (USB), INFINIBAND™ bus, and the like.

According to an embodiment, a processing circuit is implemented as at least one of a central processing unit (CPU), one or more other integrated circuits, one or more application-specific integrated circuits (ASICs), one or more field programmable gate arrays (FPGAs), one or more full-custom integrated circuits, one or more image processing hardware accelerator, an artificial intelligence processing circuit, and the like.

A non-limiting example of an inspection system is the ENLIGHT™ optical inspection system of Applied Materials Inc. of Santa Clara, California. USA. This inspection system may be modified to apply method 100.

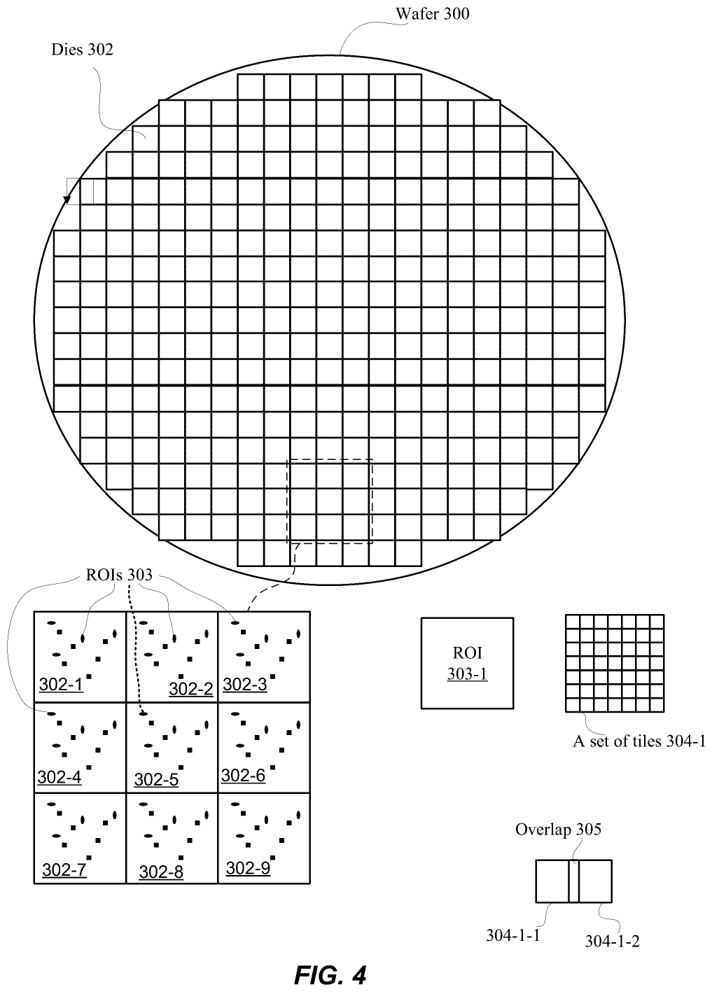

FIG. 4 illustrates an example of a wafer 300 that includes multiple dies 302, that include multiple regions of interest 303 that are virtually segmented to tiles 304. For simplicity of explanation only some of the regions of interest of some of the dies and only some of the tiles are shown in FIG. 3.

FIG. 4 also illustrates nine dies 302-1, 302-2, 302-3, 302-4, 302-5, 302-6, 302-7, 302-8 and 302-9 that includes multiple regions of interest each, the regions of interest of one die appear at the same location at another die of wafer 300.

In FIG. 4 a given region of interest of the central die (central die 302-5) has its scanning results used as a reference item when inspecting the regions of interest of the other dies (302-1 till 302-4 and 302-6 till 302-9).

FIG. 4 also illustrates a region of interest 303-1 that is associated with a set of tiles 304-1 that covers the entire region of interest. There is an overlap 305 between tile 304-1-1 and tile 304-1-2.

It should be noted that the number of regions of interest illustrated in FIG. 3, the shape and size of the regions of interest illustrated in FIG. 3, the tiles illustrated in figure are merely non-limiting examples.

Any reference to an inspection system should be applied, mutatis mutandis, to any other evaluation system such as a scanning electron microscope, a transmissive electron microscope, a metrology system, a critical dimension (CD) measurement system, an optical evaluation system, an electron beam evaluation system and the like. An Example of a CD measurement system is the VERITYSEM™ of Applied Materials Inc. of Santa Clara, California. USA. This CD measurement system may be modified to apply method 100.

In the foregoing detailed description, numerous specific details are set forth in order to provide a thorough understanding of the embodiments of the disclosure.

However, it will be understood by those skilled in the art that the present embodiments of the disclosure may be practiced without these specific details. In other instances, well-known methods, procedures, and components have not been described in detail so as not to obscure the present embodiments of the disclosure.

The subject matter regarded as the embodiments of the disclosure is particularly pointed out and distinctly claimed in the concluding portion of the specification. The embodiments of the disclosure, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the disclosure may for the most part, be implemented using electronic components and circuits known to those skilled in the art, details will not be explained in any greater extent than that considered necessary as illustrated above, for the understanding and appreciation of the underlying concepts of the present embodiments of the disclosure and in order not to obfuscate or distract from the teachings of the present embodiments of the disclosure.

Any reference in the specification to a method should be applied mutatis mutandis to a system capable of executing the method and should be applied mutatis mutandis to a computer program product that stores instructions that once executed result in the execution of the method.

Any reference in the specification to a system should be applied mutatis mutandis to a method that may be executed by the system and should be applied mutatis mutandis to a computer program product that stores instructions that can be executed by the system.

Any reference in the specification to a computer program product should be applied mutatis mutandis to a method that may be executed when executing instructions stored in the computer program product and should be applied mutandis to a system that is configured to executing instructions stored in the computer program product.

The term “and/or” means additionally or alternatively. For example A and/or B means only A, or only B or A and B.

In the foregoing description, numerous specific details are set forth in order to provide a thorough understanding of the embodiments of the disclosure.

However, it will be understood by those skilled in the art that the present embodiments of the disclosure may be practiced without these specific details. In other instances, well-known methods, procedures, and components have not been described in detail so as not to obscure the present embodiments of the disclosure.

The subject matter regarded as the embodiments of the disclosure is particularly pointed out and distinctly claimed in the concluding portion of the specification. The embodiments of the disclosure, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Any reference in the specification to a support unit should be applied mutatis mutandis to a method that may be executed by the support unit.

The term “and/or” means additionally or alternatively. For example, A and/or B means only A, or only B or A and B.

In the foregoing specification, the embodiments of the disclosure have been described with reference to specific examples of embodiments. It will, however, be evident that various modifications and changes may be made therein without departing from the broader spirit and scope of the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the disclosure described herein are, for example, capable of operation in other orientations than those illustrated or otherwise described herein.

Any reference to the term “comprising” or “having” or “including” should be applied mutatis mutandis to “consisting” and/or should be applied mutatis mutandis to “consisting essentially of”.

However, other modifications, variations and alternatives are also possible. The specifications and drawings are, accordingly, to be regarded in an illustrative rather than in a restrictive sense.

The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to embodiments containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the embodiments have been illustrated and described herein, many modifications, substitutions, changes, and equivalents will now occur to those of ordinary skill in the art. It is, therefore, to be understood that the appended claims are intended to cover all such modifications and changes as fall within the true spirit of the embodiment.

What is claimed is:

1. A wafer inspection system, comprising:
a scanner configured to scan, while following a dynamic scan plan, a set of tiles that are associated with a region of interest of a die of a wafer, to provide a set of tiles scanning results;
a comparison circuit configured to compare the set of tiles scanning results to reference items to provide a set of comparison results; wherein at least some of the reference items were generated based on one or more other sets of tiles scanning results generated by scanning one or more other sets of tiles that were associated with one or more other regions of interest; and
a decision circuit configured to determine, based on the set of comparison results, a state of the region of interest, and generate new reference items based on at least some of the set of tiles scanning results.

2. The wafer inspection system according to claim 1, further comprising a dynamic scan circuit configured to dynamically update the dynamic scan plan, based on temporal changes in an availability of wafer inspection resources allocated for wafer inspection.

3. The wafer inspection system according to claim 2, wherein the dynamic scan circuit is further configured to determine the dynamic scan plan based on one or more tile parameters, wherein the one or more tile parameters are determined based on at least one of: (i) an image quality threshold related to an acquisition of an image of a tile acquired while following the dynamic scan plan, or (ii) a field of view used while following the dynamic scan plan.

4. The wafer inspection system according to claim 2, wherein the decision circuit is further configured to determine a relevancy of a reference item to a comparison with a tile scanning result of the set of tiles scanning results based on a (i) distance between a tile associated with the tile scanning result, and a reference tile associated with the reference item, and (ii) a process variation attribute associated with the wafer.

5. The wafer inspection system according to claim 1, wherein the comparison circuit is further adapted to compare a new reference item to a number, defined in the dynamic scan plan, of tiles scanning results of further one or more regions of interest, wherein the number exceeds two, wherein the number is determined based on a memory availability attribute and a comparison latency attribute.

6. The wafer inspection system according to claim 1, wherein the set of tiles belongs to a group of tiles, wherein the scanner is configured to scan, while following the dynamic scan plan, one or more additional sets of tiles of the group of tiles before scanning one or more tiles of one or more other groups of tiles of one or more other dies of the wafer.

7. The wafer inspection system according to claim 6, wherein the group of tiles belongs to a batch of tiles, wherein the scanner is configured to scan, while following the dynamic scan plan, one or more additional groups of tiles of the batch of tiles before performing an auto-focus calibration and then proceeding to scan one or more tiles of one or more other batches of tiles of one or more further dies of the wafer.

8. The wafer inspection system according to claim 7, comprising a dynamic scan circuit configured to determine the dynamic scan plan based on at least one of (i) a mechanical stage movement parameter indicative of one or more mechanical movements of the wafer during an execution of the dynamic scan plan, (b) a calibration parameter related to a calibration necessitated during the execution of the dynamic scan plan, or (c) a memory resource parameter related to a consumption of one or more memory resources required during the execution of the dynamic scan plan.

9. The wafer inspection system according to claim 7, further comprising a recovery circuit configured to perform a recovery process following a completion of a partially failed scanning a batch of tiles.

10. A method for wafer inspection, the method comprising:
scanning, by a wafer inspection system and while following a dynamic scan plan, a set of tiles that are associated with a region of interest of a die of a wafer to provide a set of tiles scanning results;
comparing the set of tiles scanning results to reference items to provide a set of comparison results; wherein at least some of the reference items were generated based on one or more other sets of tiles scanning results generated by scanning one or more other sets of tiles that were associated with one or more other regions of interest;
determining, based on the set of comparison results, a state of the region of interest; and
generating new reference items based on at least some of the set of tiles scanning results.

11. The method according to claim 10, further comprising dynamically updating the dynamic scan plan based on temporal changes in an availability of wafer inspection resources allocated for the wafer inspection.

12. The method according to claim 10, wherein the dynamic scan plan is based on one or more tile parameters, wherein the one or more tile parameters are determined based on at least one of: (i) an image quality threshold related to an acquisition of an image of a tile acquired while following the dynamic scan plan, or (ii) a field of view used while following the dynamic scan plan.

13. The method according to claim 10, further comprising comparing a new reference item to a number, defined in the dynamic scan plan, of tiles scanning results of further one or more regions of interest, wherein the number exceeds two, wherein the number is determined based on a memory availability attribute and a comparison latency attribute.

14. The method according to claim 10, further comprising determining a relevancy of a reference item to a comparison with a tile scanning result of the set of tiles scanning results based on a (i) distance between a tile associated with the tile scanning result, and a reference tile associated with the reference item, and (ii) a process variation attribute associated with the wafer.

15. The method according to claim 10, wherein the set of tiles belongs to a group of tiles, wherein the method further comprises scanning, while following the dynamic scan plan, one or more additional sets of tiles of the group of tiles before scanning one or more tiles of one or more other groups of tiles of one or more other dies of the wafer.

16. The method according to claim 15, wherein the group of tiles belongs to a batch of tiles, wherein the method further comprises scanning, while following the dynamic scan plan, one or more additional groups of tiles of the batch of tiles before performing an auto-focus calibration and then proceeding to scan one or more other tiles of one or more other batches of tiles of one or more further dies of the wafer.

17. The method according to claim 16, wherein the dynamic scan plan is determined based on at least one of (i) a mechanical stage movement parameter indicative of one or more mechanical movements of the wafer during an execution of the dynamic scan plan, (b) a calibration parameter related to a calibration necessitated during the execution of the dynamic scan plan, or (c) a memory resource parameter related to a consumption of one or more memory resources required during the execution of the dynamic scan plan.

18. The method according to claim 16, further comprising performing a recovery process following a completion of a partially failed scanning a batch of tiles.

19. A non-transitory computer readable medium for wafer inspection, the non-transitory computer readable medium storing instructions that once executed by an inspection system, cause the inspection system to:
scan, while following a dynamic scan plan, a set of tiles that are associated with a region of interest of a die of a wafer to provide a set of tiles scanning results;
compare the set of tiles scanning results to reference items to provide a set of comparison results; wherein at least some of the reference items were generated based on one or more other sets of tiles scanning results generated by scanning one or more other sets of tiles that were associated with one or more other regions of interest;
determine, based on the set of comparison results, a state of the region of interest; and
generate new reference items based on at least some of the set of tiles scanning results.
